(19) United States
(12) Patent Application Publication
(10) Pub. No.: US 2011/0106667 A1
(43) Pub. Date: May 5, 2011

(54) System for object oriented financial accounting

(75) Inventors: Daniel Johnson, Dublin, CA (US); Saul Arjona Polo, Walnut Creek, CA (US); Lisa Macalka, Dublin, CA (US)

(73) Assignee: Workday, Inc.

(21) Appl. No.: 12/590,244

(22) Filed: Nov. 3, 2009

(51) Int. Cl. G06Q 10/00

(52) U.S. Cl. 705/30

(57) ABSTRACT

A system for accounting comprises a processor and a memory. The processor is configured to determine one or more accounting rules based at least in part on an accounting object. The processor is further configured to determine accounting for the accounting object based at least in part on the one or more accounting rules. The memory is coupled to the processor and configured to provide the processor with instructions.

### BACKGROUND OF THE INVENTION

Some accounting systems are based on a general ledger, containing all of the accounting information for each transaction processed. When a new transaction is processed, data is entered for some or all of the fields in the ledger and the new ledger balance is calculated. If additional data entry fields are desired, they become available to all general ledger entries as columns in a ledger database table, eventually causing the ledger database to have a large number of columns as many custom fields are added. A ledger may have many transaction entries, appearing as rows in the ledger table. Data processing operations on the ledger table, including sorting, searching, and report preparation, become slow and cumbersome as the table becomes very large. In addition, relations between ledger entries are cumbersome to manage in a database structure: typically, each key requires additional database table entries (e.g., a column).

### BRIEF DESCRIPTION OF THE DRAWINGS

Various embodiments of the invention are disclosed in the following detailed description and the accompanying drawings.

FIG. 1 is a block diagram illustrating an embodiment of a network system.

FIG. 2 is a block diagram illustrating an embodiment of a class data structure.

FIG. 3 is a block diagram illustrating an embodiment of a data structure for an object tree.

FIG. 4 is a diagram illustrating an embodiment of an accounting ledger.

FIG. 5 is a diagram illustrating an embodiment of an account posting rules object.

FIG. 6 is a flow diagram illustrating an embodiment of a process for creating a new object tag.

FIG. 7 is a flow diagram illustrating an embodiment of a process for processing a transaction.

FIG. 8 is a flow diagram illustrating an embodiment of a process for report creation.

FIG. 9 is a flow diagram illustrating an embodiment for generating an accounting entry.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for object oriented accounting is disclosed. The system includes an accounting object. The accounting object is associated with one or more accounting rules. The one or more accounting rules enables generation of accounting for the accounting object.

In some embodiments, an accounting system comprises an object oriented accounting system. An accounting system object or data associated with the object can be associated with other data by having relationships. New data can be added to an accounting object without necessarily being affected by other data associated with other objects. Further, the Reports and ledger entries are generated using accounting rules associated with the account objects of the accounting system. The accounting rules use other objects associated with the account object using one or more object tag(s).

In some embodiments, the object oriented accounting system comprises a system for maintaining and processing a set of objects. The objects include human resources objects (e.g., employees, business locations, regions, etc.) and accounting objects (e.g., vendors, goods, cost centers, transactions, accounts, etc.), as well as an account posting rule object for assigning transaction objects to accounts. Transaction objects are assigned to accounts based on relationships to other objects. Additionally, account reporting is created based on relationships between objects. New objects are created by a user to allow accounting and reporting based on custom fields without affecting processing not involved with the custom field.

In some embodiments, the system for object oriented accounting is implemented on an application server connected to a network. The application server comprises software for object oriented accounting along with network communication hardware for communicating with users (e.g., an accounting system administrator, an accounting system user) accessing the network from different points.

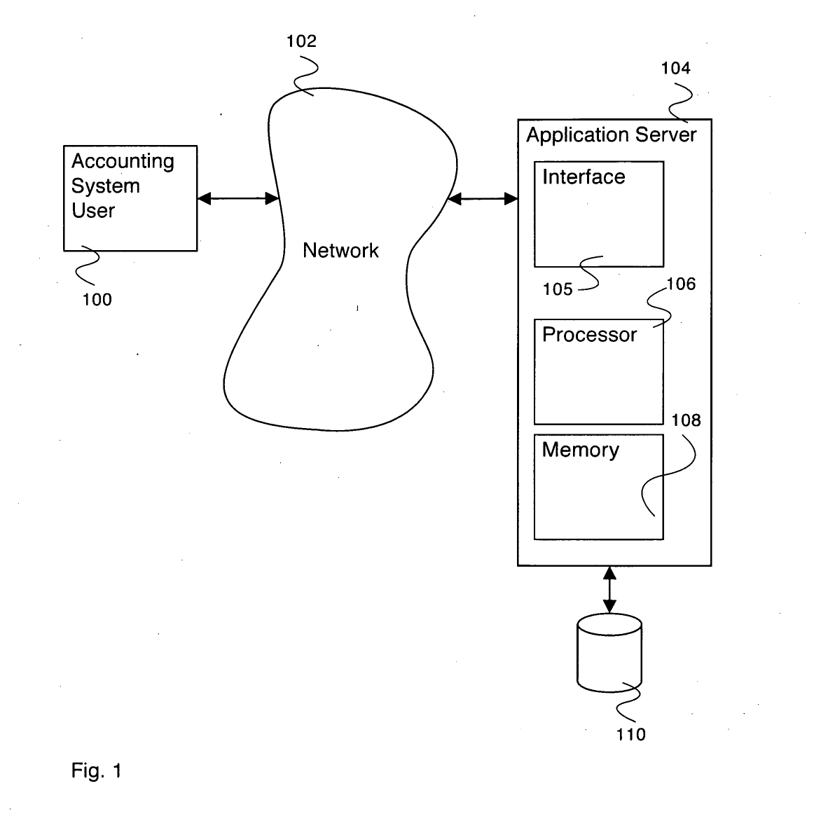

FIG. 1 is a block diagram illustrating an embodiment of a network system. In the example shown, application server 104 includes interface 105, processor 106 and memory 108. Application server 104 is coupled to external storage 110 so that application server 104 is able to store information to and access information from external storage 110. Application server 104 is also coupled to network 102 using interface 105. In various embodiments, network 102 comprises one or more of the following: a local area network, a wide area network, a wired network, a wireless network, the Internet, or any other appropriate network. Accounting system user 100 accesses application server 104 using network 102. In some embodiments, accounting system user 100 accesses an application running on application server 104. The application processes accounting based on stored data. In various embodiments, stored data is related to a business requirement such as an expense report, a personnel file, data related to an employee, or any other relevant data. In some embodiments, stored data is stored in an object-based database. In various embodiments, the application comprises an enterprise application, a human resources application, a business process application, a finance application, a content management application, or any other appropriate application.

In various embodiments, application server 104 comprises one or more physical servers with one or more processors, one or more memories, and one or more other storage devices (e.g., hard drives, array of drives, etc.) and/or one or more virtual environments (e.g., virtualization of operating system or application processes) in which an application is executed.

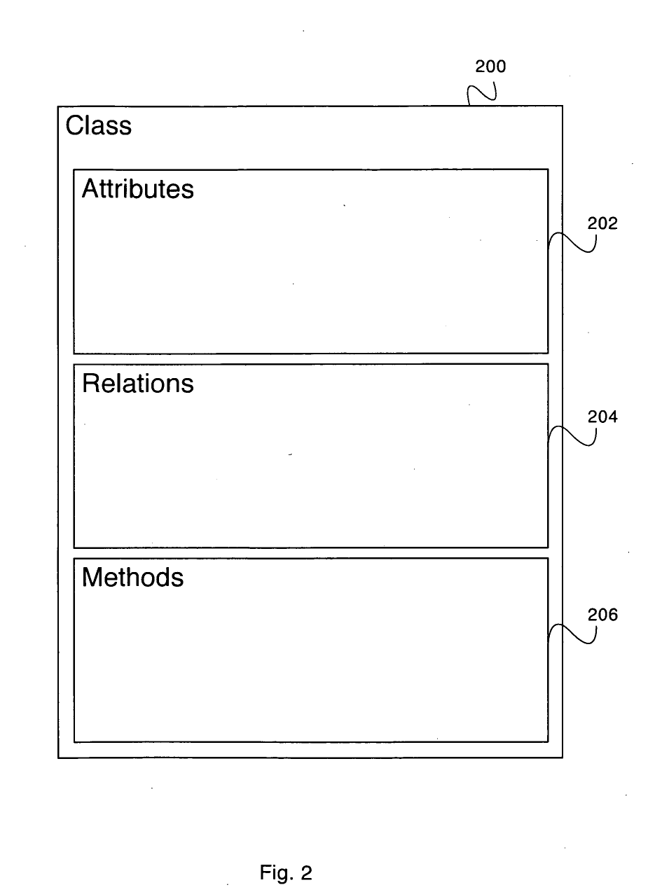

FIG. 2 is a block diagram illustrating an embodiment of a class data structure. In some embodiments, stored data (e.g., data stored in external storage 110 of FIG. 1) is stored in class data structures of FIG. 2. In the example shown, class 200 is comprised of zero, one, or more than one attributes 202, zero, one, or more than one relations 204, and zero, one, or more than one methods 206. Attributes 202 store data about the class, for instance, name, location, salary, title, cost, vendor, or any other human resource, corporate, financial, legal, or medical data, or any other appropriate data. Relations 204 store relations between a given object instance of class 200 and other object instances of the class or of other class definitions. Methods 206 define operations that can be performed with the attributes and relations. A given class definition has a certain set of attributes and relations, as well as a certain set of methods used to operate on those attributes and relations. A given object instance of a class definition has defined values for each of the attributes and relations.

In some embodiments, object classes can inherit from one another. When a child object class inherits from a parent object class, it takes on the class definition of the parent object. The class definition of the child object can then be extended by adding or overwriting methods, attributes, or relations.

In some embodiments, object classes are defined as part of software sold by a system vendor and used by a system user (e.g., accounting system user 100 of FIG. 1). In some embodiments, a system user can create new classes as desired in order to customize and/or extend the software sold by the system vendor.

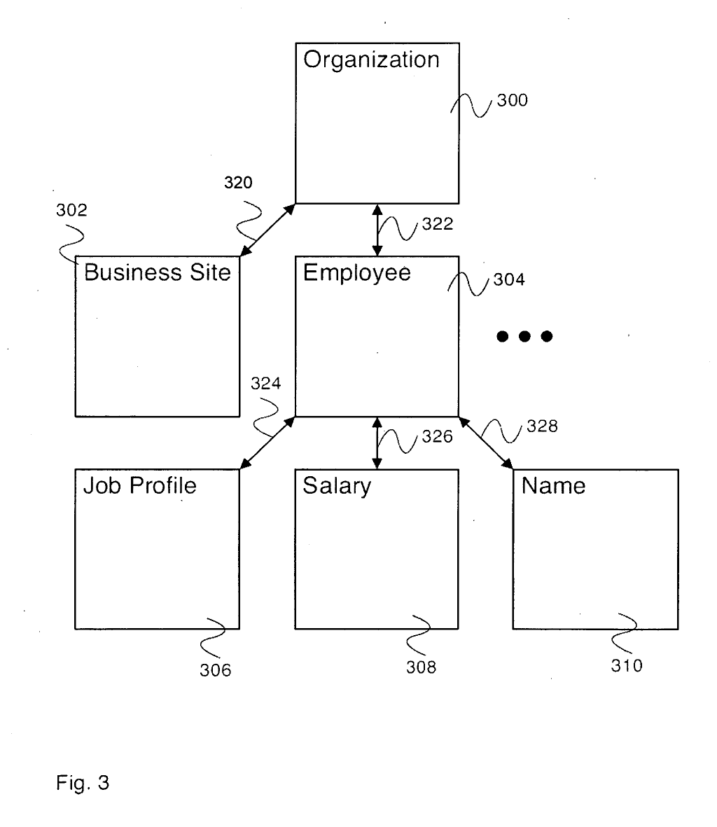

FIG. 3 is a block diagram illustrating an embodiment of a data structure for an object tree. In some embodiments, the object tree of FIG. 3 may comprise stored data in an application server (e.g., application server 104 of FIG. 1). In some embodiments, objects 300, 302, 304, 306, 308, and 310 comprise object instances of class data structures as shown in FIG. 2. In some embodiments, relations 320, 322, 324, 326, and 328 comprise relations referred to in FIG. 3. In the example shown, objects represented in FIG. 3 represent a part of a business data structure. Organization 300 has relation 320 to business site object 302. Business site object 302 contains the name of the site at which the organization resides. Organization 300 also has relation 322 to employee objects such as employee object 304, each representing an employee that is part of the organization. Employee object 304 has relation 324, relation 326, and relation 328 to job profile object 306, salary object 308, and name object 310, respectively. Job profile object 306 includes job profile attributes corresponding to employee 304. Salary object 308 includes salary attributes corresponding to employee 304. Name object 310 includes name attributes corresponding to employee 304. In this way, data can be stored in a way representing the organizational structure of the company. In some embodiments, programs can access attribute data throughout the object tree by traversing the object tree along the connections between objects given by relationships, and operate on the accessed attribute data to create a meaningful report about the organization.

In some embodiments, a system user (e.g., accounting system user 100 of FIG. 1) can create a new object class (e.g., object class 200 of FIG. 2) and create relations from object instances in the object tree (e.g., objects 300, 302, 304, 306, 308, or 310) to instances of the new class. In this way, object instances in the object tree with relations to the instance of the new class become “tagged,” and can be identified based on the tag. In various embodiments, reports can be created based on object tags, object processing can be modified based on object tags, objects can be searched based on object tags, or any other appropriate action can be taken based on object tags. In some embodiments, an object map comprises an object tree.

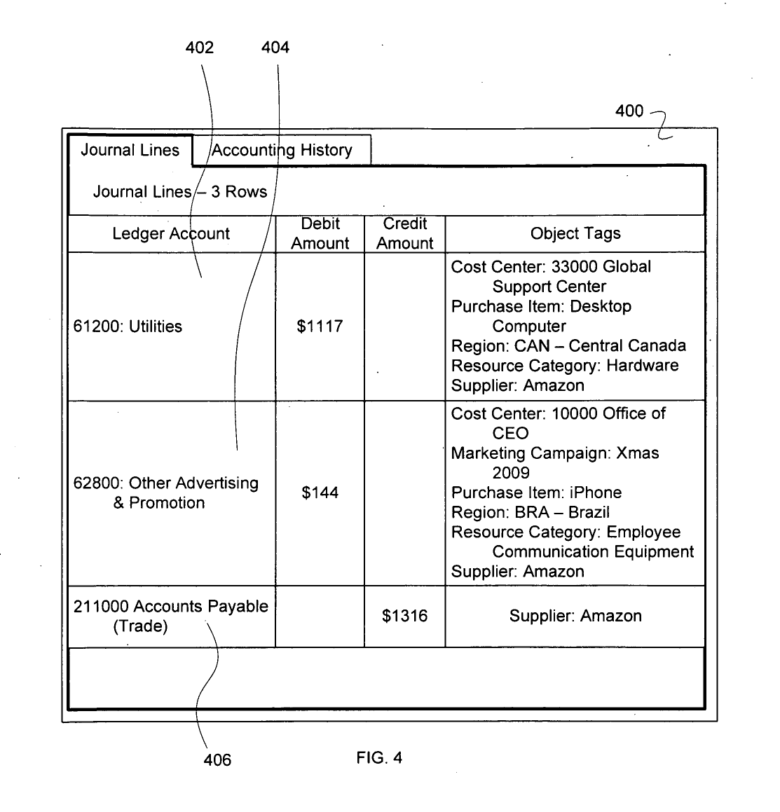

FIG. 4 is a diagram illustrating an embodiment of an accounting ledger. In some embodiments, journal lines of journal window 400 are stored in an application server (e.g., application server 104 of FIG. 1). In some embodiments, journal lines of journal window 400 are created based on data stored in an object tree (e.g., the object tree of FIG. 3). In the example shown, journal lines of journal window 400 store the results of accounting transactions entered by an accounting system user (e.g., accounting system user 100 of FIG. 1). Each row of journal lines of journal window 400 corresponds to one accounting transaction. The columns store the account that the transaction corresponds to, applicable debits or credits for the transaction, and any object tags associated with the transaction. In some embodiments, each transaction is stored in the application server as an instance of an object in an object tree, and object tags represent relations (e.g., relations 204 of FIG. 2) between the transaction object and another applicable object indicated to have a relation to the transaction. In some embodiments, the object tag is indicated by the accounting system user when entering the transaction. In some embodiments, the objects that the transaction object instances are indicated to have relations with are defined in the software before it is delivered to the accounting system user. In some embodiments, the objects that the transaction object instances are indicated to have relations with are defined by the accounting system user.

In some embodiments, journal lines of journal window 400 are created by software on the application server after processing a transaction in order to maintain a human-readable record of accounting transactions. In some embodiments, a human-readable record of accounting transactions is not necessary and journal lines in journal window 400 are not created.

In the example shown in FIG. 4, journal window 400 includes ledger account, debit amount, credit amount, and object tags. Row 402 shows ledger account 61200: utilities with a debit amount $1117 and object tags—cost center: 33000 (e.g., global support center); purchase item: desktop computer; region: CAN—Central Canada; resource category: hardware; and supplier: Amazon. Row 404 shows ledger account 62800: other advertising & Promotion with a debit amount $199 and object tags—cost center: 10000 office of CEO; marketing campaign: Xmas 2009; purchase item: iPhone; region: BRA—Brazil; resource category: employee communications equipment; supplier Amazon. Row 406 shows ledger account 21100: accounts payable (trade) with a credit amount of $1316 and object tags—supplier: Amazon. In some embodiments, the associated object tags for journal entries enables calculation based at least in part on the object tags.

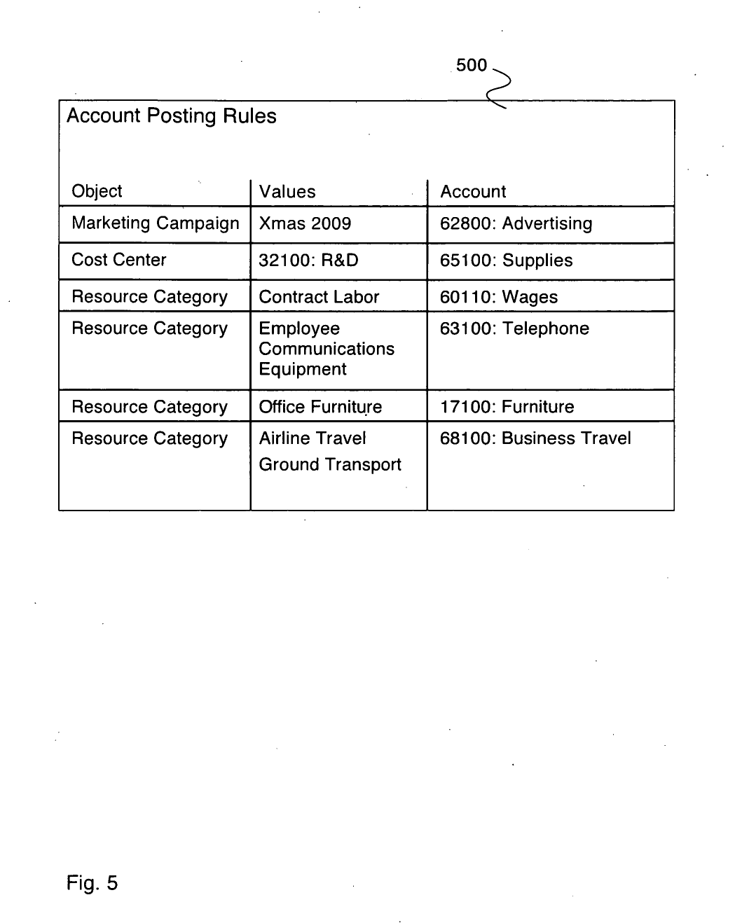

FIG. 5 is a diagram illustrating an embodiment of an account posting rules object. In some embodiments, account posting rules object 500 is stored in an application server (e.g., application server 104 of FIG. 1). In the example shown, account posting rules object 500 is used to determine the account that a given transaction is associated with. In some embodiments, account posting rules object 500 determines the account that a given transaction is associated with based on relations (e.g., relations 204 of FIG. 2) between the transaction object and other objects. When the transaction is created relations between the transaction object and other objects are indicated; these relations are compared to the list of objects stored in account posting rules object 500, and when an object is found in the list that the transaction object has a relation to, the corresponding account is assigned to the transaction object. Account posting rules object 500 can also store values stored as object attributes (e.g., attributes 206 of FIG. 2), such that two different instances of the same object can be used as object tags. For instance, if the transaction has a relation to a marketing campaign object with value Xmas 2009, account posting rules object 500 assigns the transaction to account 62800: Advertising. If the transaction object has a relation to a resource category object with value contract labor, it is assigned to account 60110: Wages, but if it has a relation to a resource category object with value communications it is assigned to account 63100: Telephone. In some embodiments, multiple object values can be checked against. For instance, if the transaction object has a relation to a resource category object with a value of either airline travel or ground transport, it is assigned to account 68100: Business Travel.

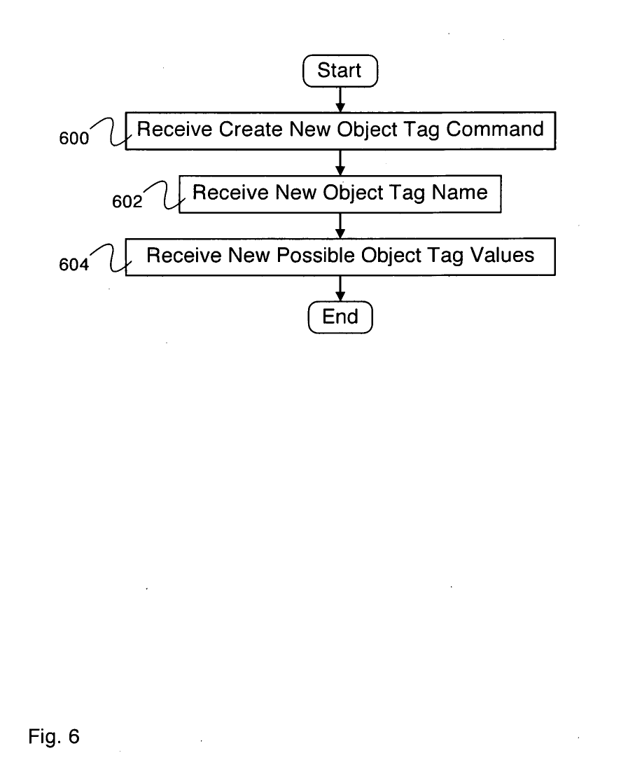

FIG. 6 is a flow diagram illustrating an embodiment of a process for creating a new object tag. In some embodiments, the process of FIG. 6 is executed by software running on an application server (e.g., application server 104 of FIG. 1) in response to commands given by a system user (e.g., accounting system user 100 of FIG. 1). In the example shown, in 600, the ‘create new object command’ is received. The software then creates a new object instance to serve as the object tag. In 602, the new object tag name (e.g., marketing campaign, line of business, sales channel) is received, and the software assigns the object tag name to the newly created object. In 604, new possible object tag values (e.g., contract labor, communications, office furniture) and the software defines the values as possible values for instances of the object. The new object tag is then finished being created and is available to tag transactions or other objects with, and the process ends.

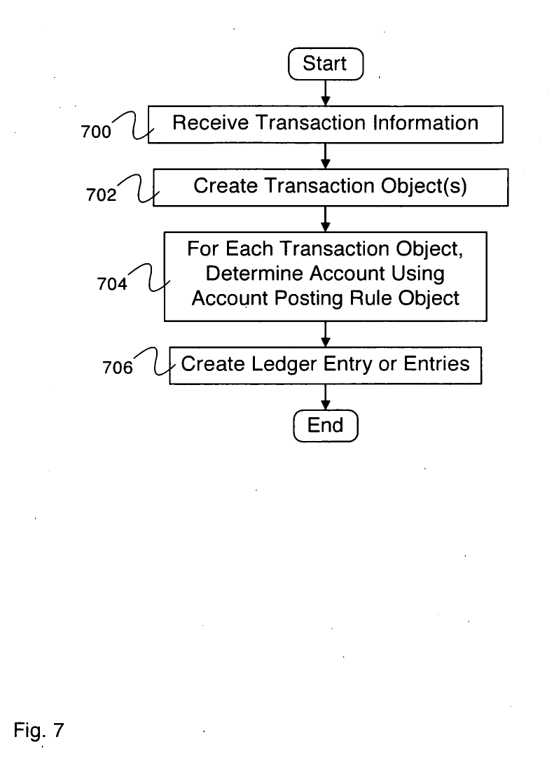

FIG. 7 is a flow diagram illustrating an embodiment of a process for processing a transaction. In some embodiments, the process of FIG. 7 is executed by software running on an application server (e.g., application server 104 of FIG. 1). In the example shown, in 700, transaction information is received. In various embodiments, transaction information is received from a system user (e.g., accounting system user 100 of FIG. 1), from a remote system attached to the network (e.g., network 102 of FIG. 1), from an automatically running process on the application server or on another computer, or from any other appropriate source of transaction information. In 702, one or more transaction objects are created based on the transaction information received in 700. In some embodiments, one transaction object is created for each part of the transaction (e.g., a credit part and a debit part). In some embodiments, transaction objects are created with relations to object tags as indicated in the transaction information received in 700. In 704, for each transaction object, the account is determined using the account posting rule object (e.g., account posting rule object 500 of FIG. 5). The account posting rule object assigns the account for the transaction based on relations associated with the account. In 706, an entry or entries are created in the ledger (e.g., ledger 400 of FIG. 4), storing the transaction name, debits or credits, and associated object tags, and the process ends. In some embodiments, the ledger is not created.

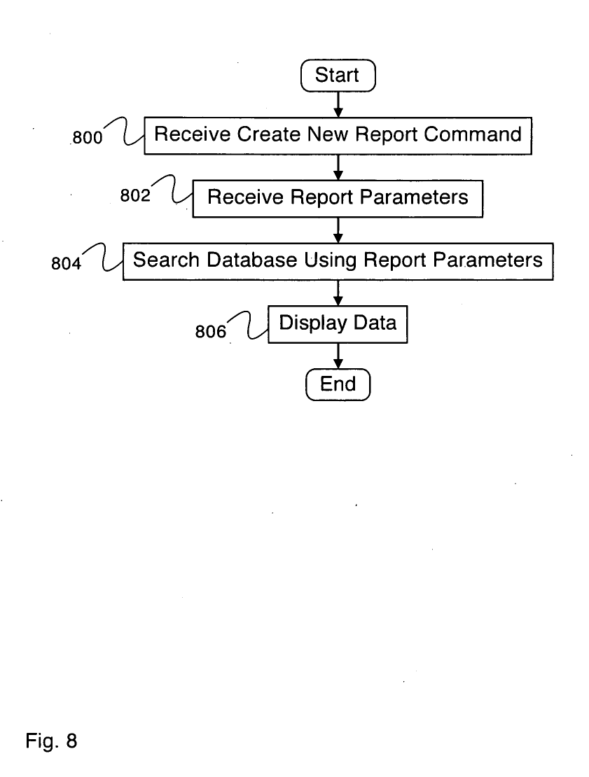

FIG. 8 is a flow diagram illustrating an embodiment of a process for report creation. In some embodiments, the process of FIG. 6 is executed by software running on an application server (e.g., application server 104 of FIG. 1) in response to commands given by a system user (e.g., accounting system user 100 of FIG. 1). In the example shown, in 800, the command to create a new report is received. In 802, report parameters are received. In various embodiments, report parameters comprise data, object attributes (e.g., object attributes 202 of FIG. 2), object tags, object classes, or any other appropriate report parameters. In 804, the database is searched according to the report parameters. In various embodiments, the database is searched for objects with matching attributes to those specified in the report parameters, with matching object classes to those specified in the report parameters, with relations (e.g., relations 204 of FIG. 2) to object tags specified in the report parameters, or according to any other appropriate searching scheme. In 806, data found in 804 is displayed. In various embodiments, displayed data is filtered, sorted, or processed in any other appropriate way. The process then ends.

In some embodiments, when a financial transaction is entered into the system, a number of objects are created and a number of relationships are established among these objects as well as with other objects already existing in the system. Some of these newly created objects have accounting impact and their existence result in accounting entries being created or modified. Every object that is created as part of a transaction and that has accounting impact is provided with an accounting behavior that allows it to generate the proper accounting for itself. As part of this accounting self-generation, objects expose a number of dimensions which are used to determine what kind of accounting the object generates. These dimensions include, but are not limited to, all the object tags that the object has relationships to. Object tags allow users to “tag” transaction lines with a somewhat unlimited number of objects and object types that either already exist in the system (e.g., cost centers, regions, projects, etc.) or have been created by the user for this purpose (e.g., marketing campaign, custom object tags). The mapping between the dimensions exposed by the objects and the accounting behavior happens through the account posting rule object. This object allows users to define their accounting rules based on any of the dimensions available in the system (e.g., object tags). This way, accountable objects can be tagged with potentially any object type in the system and accounting rules can be defined based on any of these tags, becoming a completely open and flexible accounting system.

### Supplier Invoice Example

In this example, a company purchases a desktop computer and an iPhone from Amazon. Both items are being acquired for some specific cost centers and regions, which already exist in the accounting system as part of an organization setup. The iPhone is purchased as part of a “Xmas 2009” marketing campaign. Marketing campaign is not currently an object set up to be tracked. Special accounting rules need to be set up for transactions which are part of the “Xmas 2009” marketing campaign.

To achieve this, a custom object tag is enabled for the marketing campaign. The usage for the tag is defined (e.g., financial). The potential values for the work tag are defined (e.g., ‘Back to College’, ‘Friends & Family’, ‘Xmas 2009’, etc.). A rule is modified or created to introduce the new accounting behavior based on the ‘marketing campaign’ dimension.

In some embodiments, a rule set includes a default rule (e.g., default ledger account is ‘69999: Uncategorized Expense). In some embodiments, a rule comprises a condition (e.g., a dimension with an associated value and a resulting ledger account). For example, similar to account posting rules of FIG. 5, a cost center dimension with a value of 32100 R&D—Product Strategy has an associated resulting ledger account of 65100: Supplies; a resource category dimension with a value of ‘contract labor expense’ has an associated resulting ledger account of 60110: Wages; a resource category dimension with a value of ‘employee communication equipment’ has an associated resulting ledger account of 63100: Telephone; a resource category dimension with a value of ‘office furniture’ has an associated resulting ledger account of 17100: Furniture; and a resource category dimension with a value of ‘airline travel’ or ‘ground transportation’ has an associated resulting ledger account of 68100: Business Travel.

A new rule (e.g., a posting rule) is added to add a new accounting behavior—for example, a marketing campaign dimension with a value of ‘Xmas 2009’ has an associated resulting ledger account of 62800: Advertising. A supplier invoice has a supplier value of ‘Amazon’. The invoice has input fields (e.g., currency, invoice date, due date, due date override, control total amount, total invoice amount, payment terms, discount date, on hold status, supplier document received status, external PO number, supplier contract, total contract, etc.). The invoice entry for the company includes a company name, an item, a resource category, a quantity, a unit cost, an extended amount, a memo, and object tags. For example, an item of a ‘desktop computer’, a quantity of ‘1’, a resource category of ‘hardware’, a unit cost of ‘$1117’, object tags of ‘cost center: 33000 global support center’ and ‘region: CAN—central Canada’; and an item of an ‘iPhone’, a resource category of ‘employee communication equipment’, a quantity of ‘1’, a unit cost of ‘$199.99’, and object tags of ‘cost center: 10000 office of CEO’, ‘Marketing campaign: Xmas 2009’, and region: BRA—Brazil.

As soon as the invoice is saved by the user, three objects are created; one instance of ‘supplier invoice header’ and two instances of ‘supplier invoice line’. All three objects have accounting implications. Each of the objects exposes their own dimensions and obtains their respective accounting behaviors:
a) The supplier invoice header object—exposes both ‘company’ and ‘supplier: Amazon’ as dimensions as well as ‘supplier group: administration’ and ‘supplier category: Trade’ which are tied to the supplier object. Using the four exposed dimensions, the posting rule object (e.g., a payables posting rule object) determines that the invoice needs to use a specific account (e.g., when dimension supplier category is trade then resulting ledger account is the ‘21100 accounts payable (trade)’ account). The accounting behavior is what tells the system which posting rule object (e.g. payables, resource, etc.) is used for a given transaction object. For example, it says that the Supplier Invoice Header creates a credit entry to the Payables posting type and the Supplier Invoice Line creates a debit entry to the Resource posting type);
b) The first supplier invoice line—exposes dimensions: ‘company’, ‘supplier: amazon’, ‘supplier group: administration’, ‘supplier category: trade’, ‘item: desktop computer’, ‘resource category: hardware’, ‘purchase item group: IT’, ‘cost center: 33000’, and ‘region: Canada’. Using the exposed dimensions, the posting rule object (e.g., the resource posting rule object) determines that the invoice needs to use the default account (e.g., none of the conditions are met in the resource posting rule object, so the default is used: for example, 69999: Uncategorized Expense is the default ledger account). The accounting behavior in the case of supplier invoice determines the default account by looking at a posting type of resource; and
c) The second supplier invoice line—exposes dimensions: ‘company’, ‘supplier: amazon’, ‘supplier group: administration’, ‘supplier category: trade’, ‘item: iPhone’, ‘resource category: employee communication equipment’, ‘purchase item group: Computers’, ‘cost center: 10000’, ‘region: Brazil’, and ‘marketing campaign: Xmas 2009’. Using the exposed dimensions, the posting rule object (e.g., the resource posting rule object) determines that the invoice needs to use a specific ledger account (e.g., the conditions of the dimension marketing campaign having value of Xmas 2009 is met in the resource posting rule object, so the resulting account is 62800 Advertising).

The rules enable the generation of journal ledger entries similar to FIG. 4.

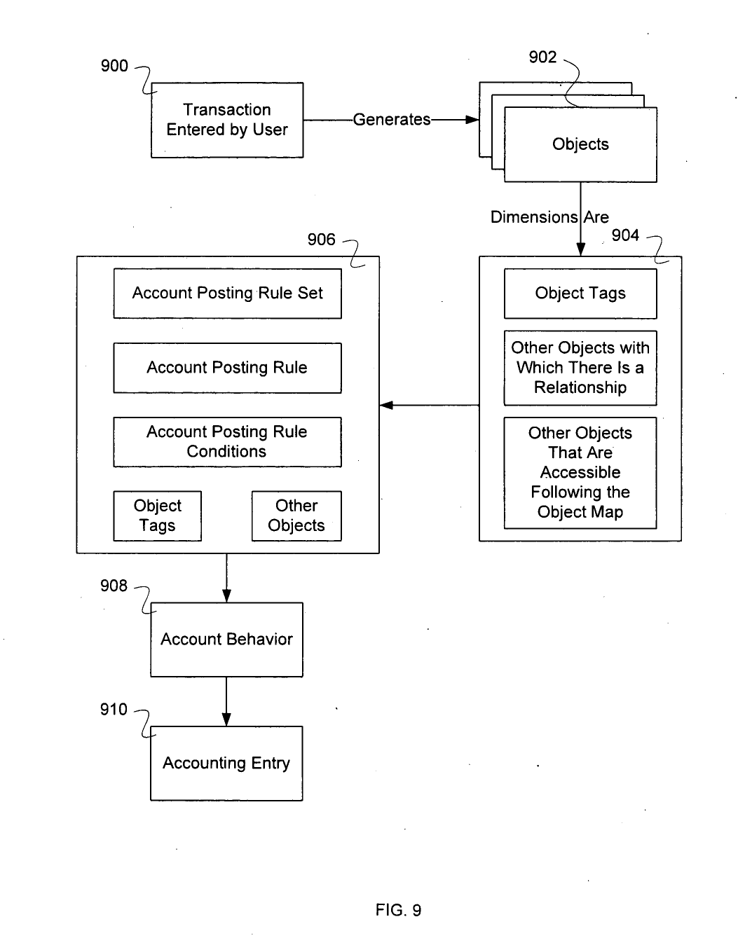

FIG. 9 is a flow diagram illustrating an embodiment for generating an accounting entry. In the example shown, in 900 a transaction is entered by a user. In various embodiments, a transaction comprises one or more of the following: a user selection in a menu, a user command, a user request to enter new data, a user request to enter new financial information, a user request to create, modify, or delete Supplier Invoices, Supplier Invoice Adjustments, Customer Invoices, Customer Invoice Adjustments, Expense Reports, Accounting Journals, Asset Depreciation, Payments and Allocations, or any other appropriate transactions. In 902, the transaction generates object(s). In 904, the dimensions are enumerated from object tags, other object with which there is a relationship, and other objects that are accessible following the object map. In 906, the account posting rule set is used to identify an appropriate account posting rule for which account posting conditions are evaluated based on object tags and based on other objects. In 908, account behavior is determined. In 910, accounting entry or entries are determined.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for accounting, comprising:
a processor configured to:
determine one or more accounting rules based at least in part on an accounting object; and
determine accounting for the accounting object based at least in part on the one or more accounting rules; and
a memory coupled to the processor and configured to provide the processor with instructions.

2. A system as in claim 1, wherein the accounting object is one of a plurality of accounting objects.

3. A system as in claim 1, wherein a rule of the one or more accounting rules is associated with an object tag and wherein the object tag is associated with the accounting object.

4. A system as in claim 3, wherein the object tag is generated in response to a user request.

5. A system as in claim 3, wherein the object tag is used for deriving an accounting journal entry.

6. A system as in claim 1, wherein the accounting object includes a method.

7. A system as in claim 1, wherein the accounting object includes a relationship.

8. A system as in claim 1, wherein one rule of the one or more accounting rules is generated in response to a user request.

9. A system as in claim 1, wherein determining accounting comprises generating one or more journal entries based at least in part on the accounting object and the one or more accounting rules.

10. A system as in claim 9, wherein a report is generated based at least in part on the one or more journal entries.

11. A system as in claim 9, wherein the accounting object has one or more associated object tags and one or more associated other objects that are used to determine the one or more accounting rules.

12. A system as in claim 9, wherein the accounting object is generated based at least in part on a user entered transaction.

13. A system as in claim 12, wherein the user generated transaction comprises one or more of the following: a user selection in a menu, a user command, a user request to enter new data, a user request to enter new financial information, or a user request to create, modify, or delete Supplier Invoices, Supplier Invoice Adjustments, Customer Invoices, Customer Invoice Adjustments, Expense Reports, Accounting Journals, Asset Depreciation, Payments and Allocations.

14. A system as in claim 1, wherein one rule of the one or more accounting rules comprises a default rule.

15. A system as in claim 14, wherein the default rule assigns a default account.

16. A method for accounting, comprising:
determining one or more accounting rules based at least in part on an accounting object; and
determining accounting for the accounting object based at least in part on the one or more accounting rules.

17. A computer program product for accounting, the computer program product being embodied in a computer readable storage medium and comprising computer instructions for:
determining one or more accounting rules based at least in part on an accounting object; and
determining accounting for the accounting object based at least in part on the one or more accounting rules.
